(19) United States
(12) Patent Application Publication
(10) Pub. No.: US 2010/0007983 A1
(43) Pub. Date: Jan. 14, 2010

(54) MAGNETIC RECORDING APPARATUS AND METHOD FOR POSITIONING HEAD

(75) Inventors: Kei Funabashi, Kawasaki (JP); Shinji Koganezawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/495,055

(22) Filed: Jun. 30, 2009

(30) Foreign Application Priority Data
Jul. 10, 2008 (JP) 2008-179921

(51) Int. Cl. G11B 21/02

(52) U.S. Cl. 360/75; G9B/21.003

(57) ABSTRACT

According to an aspect of the embodiment, a magnetic recording apparatus has a sensor detecting a first signal including disk flutter and arm flexural vibration and a sensor for detecting a second signal only including the arm flexural vibration. The magnetic recording apparatus obtains the frequency component of disk flutter based on the first signal and second signal, and executes the control of positioning a head based on the obtained frequency component of the disk flutter.

### CROSS-REFERENCE TO RELATED APPLICATIONS

This application is based upon and claims the benefit of priority of the prior Japanese Patent Application No. 2008-179921, filed on Jul. 10, 2008, the entire contents of which are incorporated herein by reference.

### FIELD

The embodiments discussed herein are related to a magnetic recording apparatus and a method for positioning a head in a magnetic recording apparatus.

### BACKGROUND

In recent years, recording density of a magnetic recording apparatus such as a magnetic disk has increased. Due to the increasing of the recording density, it is required for the magnetic recording apparatus to accurately positioning for causing a head such as a magnetic head to follow a predetermined track on a magnetic recording medium such as a magnetic disk, for example. However, there is wind generated by a rotation of a disk, and disk flutter caused by the wind significantly adversely affects the positioning accuracy of the head. The disk flutter is a vibration in the direction perpendicular to a disk plane of the disk itself.

A technique for controlling positioning a magnetic head is proposed which uses a piezoelectric element, a capacity sensor or a strain sensor provided on a suspension, an arm, or a housing supporting the suspension to detect disk vibration, and executes feed-forward (FF) control according to the detected disk vibration (refer to Japanese Patent Laid-Open No. 2006-107708 and Japanese Patent Laid-Open No. 2003-217244, for example).

### SUMMARY

According to an aspect of the embodiment, a magnetic recording apparatus includes a first sensor detecting a first signal including disk flutter and arm flexural vibration, a second sensor detecting a second signal only including the arm flexural vibration, and control unit obtaining a frequency component of disk flutter based on the first signal and second signal, and executing control of positioning a head based on the obtained frequency component of the disk flutter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of a block diagram of a magnetic recording apparatus according to the first embodiment;

FIG. 2 is an example of an enlarged view of an actuator;

FIG. 3 is a flowchart for positioning the head;

FIG. 4 is a graph indicating a first signal;

FIG. 5 is a graph indicating a second signal;

FIG. 6 is a graph indicating the frequency component of disk flutter;

FIG. 7 is a graph indicating a positional error signal spectrum;

FIG. 8 is an example of a block diagram of a magnetic recording apparatus according to the second embodiment;

FIG. 9 is a flowchart for positioning a head;

FIG. 10 is an example of a block diagram of a magnetic recording apparatus according to the third embodiment;

FIG. 11 is an enlarged view of an actuator;

FIG. 12 is a flowchart for positioning the head;

FIG. 13 is an example of a block diagram of a magnetic recording apparatus according to the fourth embodiment;

FIG. 14 is a flowchart for positioning the head;

FIG. 15 is a graph illustrating an example of a positional error signal spectrum obtained when FF control is not executed; and

FIG. 16 is a graph illustrating an example of a sensor signal spectrum obtained from a sensor mounted on a suspension.

### DESCRIPTION OF EMBODIMENTS

We study the above described technique in which the sensor is mounted to the suspension or to the arm supporting the suspension. In this technique, there is a possibility that another vibration which does not appear in a positional error signal may be detected in the vicinity of a disk flutter frequency desired to be suppressed by FF control depending on the shape of the suspension or the arm and a method of fixing the sensor. For example, if a high-sensitive sensor is mounted on the suspension to detect disk flutter, the flexural vibration of the arm supporting the suspension (arm flexural vibration) may be detected together with disk flutter in the vicinity of a disk flutter frequency desired to be suppressed.

The arm flexural vibration hardly appears in the positional error signal. For this reason, if the FF control is performed using the sensor signal (a signal detected by the sensor) including the arm flexural vibration, the disk flutter cannot be sufficiently suppressed, and also the positioning accuracy of a magnetic head is degraded.

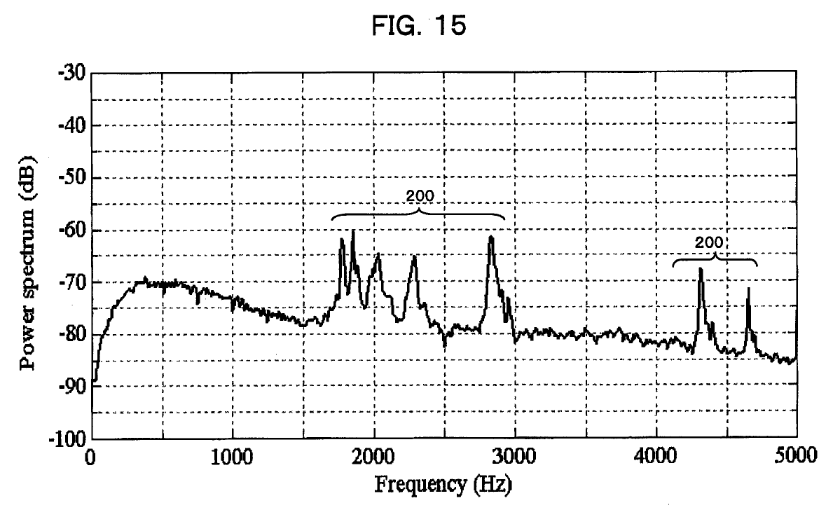

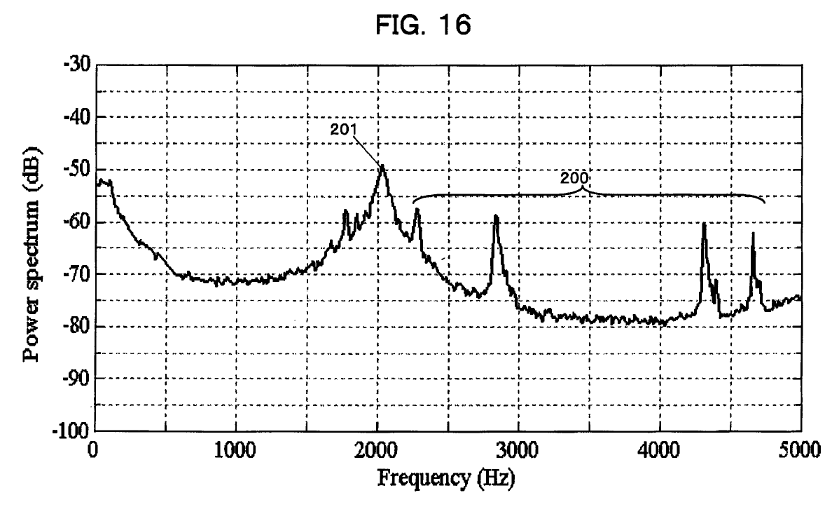

The above technical problems studied by us are described in detail below with reference to FIGS. 15 and 16. FIG. 15 is a graph illustrating an example of a positional error signal spectrum, which is obtained from a magnetic head of a magnetic disk unit, in a case where the FF control for suppressing disk flutter is not executed. In FIG. 15, a horizontal axis represents frequency (Hz), and a vertical axis represents power spectrum (dB). This is same in other graphs. As illustrated in FIG. 15, a disk flutter 200 in the magnetic disk unit exists at around 1.5 kHz to 4.5 kHz. FIG. 16 is a graph illustrating an example of a sensor signal spectrum, which is obtained from a sensor mounted on a suspension. In FIG. 16, an arm flexural vibration 201 in addition to the disk flutter 200 appears at around 2 kHz in such a way as to hide the disk flutter. If the FF control is executed using a sensor signal including the arm flexural vibration 201 illustrated in FIG. 16, the positioning accuracy of a magnetic head is degraded.

A magnetic recording apparatus disclosed bellow obtains a frequency component only of disk flutter to accurately control positioning a head based on the obtained frequency component of the disk flutter.

A method of controlling the positioning a head disclosed bellow obtains a frequency component only of disk flutter to accurately control positioning a head based on the obtained frequency component of the disk flutter.

Preferred embodiments of the present invention will be explained with reference to accompanying drawings.

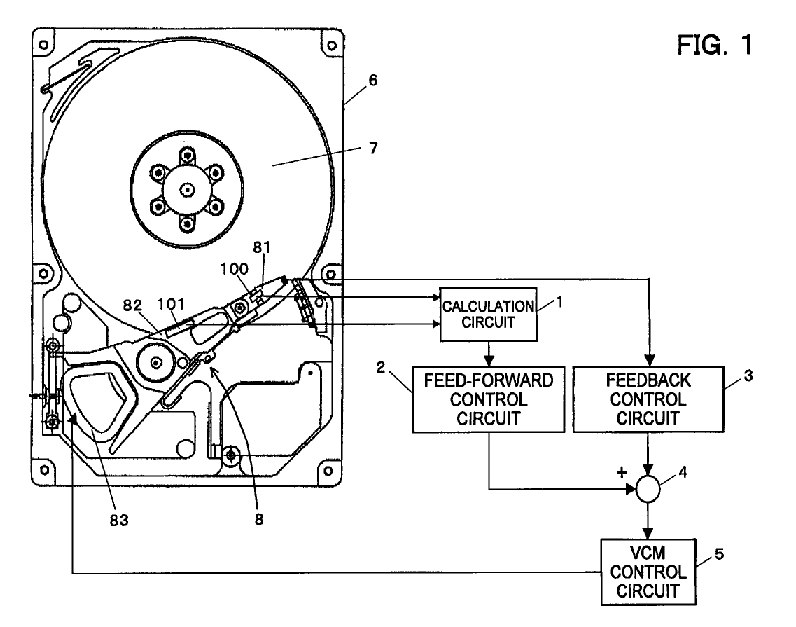

A first embodiment is described below. FIG. 1 is an example of a block diagram of a magnetic recording apparatus according to the first embodiment. The magnetic recording apparatus of the first embodiment is a magnetic disk apparatus, for example. The magnetic recording apparatus includes a housing 6, which includes a disk 7 such as a magnetic disk, and an actuator 8. Further, the magnetic recording apparatus includes a calculation circuit 1, a feed-forward (FF) control circuit 2, a feedback control circuit 3, an addition unit 4, and a Voice Coil Motor (VCM) control circuit 5. The actuator 8 in the housing 6 includes a suspension 81, an arm 82, and a VCM 83. The suspension 81 supports a head such as a magnetic head. The arm 82 supports the suspension. The VCM 83 is controlled by a VCM control circuit 5, which will be described later, to execute the control of positioning the head.

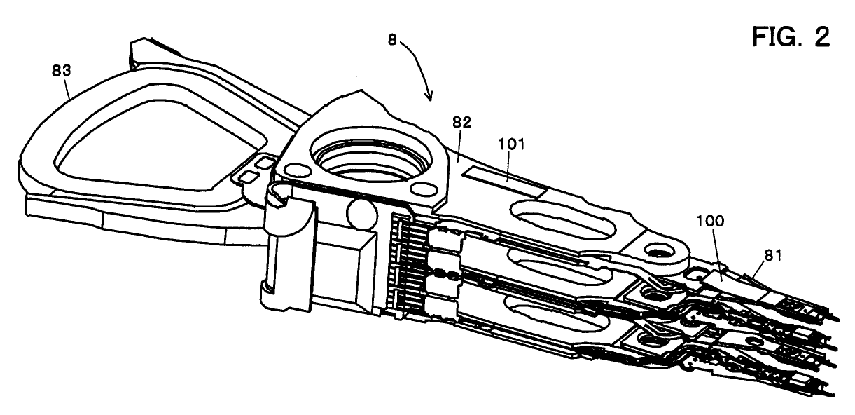

FIG. 2 is an example of an enlarged view of an actuator 8 in FIG. 1. As illustrated in FIG. 2, a sensor 100 is provided on the suspension 81, and a sensor 101 is provided on the arm 82. The sensor 100 provided on the suspension 81 detects a first signal. The first signal includes disk flutter and arm flexural vibration, since the sensor 100 provided on the suspension 81 which is provided on the top of the arm 82. The sensor 101 provided on the arm 82 detects a second signal. The second signal includes only arm flexural vibration, since the sensor 100 provided on the arm 82. For example, each of the sensor 100 and sensor 101 is a strain sensor, a piezoelectric element or a capacity sensor. A Polyvinylidene fluoride film (PVDF) sensor may be used as the sensor 100 and sensor 101.

Referring to FIG. 1 again, the calculation circuit 1 obtains (calculates) the frequency component of disk flutter based on the first signal detected by the sensor 100 and the second signal detected by the sensor 101. The sensor 100 detects and outputs the first signal to the calculation circuit 1, and the sensor 101 detects and outputs the second signal to the calculation circuit 1. The calculation circuit 1 may calculate a linear combination of the first signal detected by the sensor 100 and the second signal detected by the sensor 101 to obtain the frequency component of disk flutter. For example, to obtain the linear combination, the frequency component of arm flexural vibration included in the second signal is removed from the frequency component of the first signal. The calculation circuit 1 outputs the frequency component of disk flutter to the feed-forward control circuit 2.

The feed-forward control circuit 2 calculates a control variable (a first control variable) based on the frequency component of disk flutter, and outputs the first control variable to the addition unit 4. The control variable is used for suppressing the calculated frequency component of disk flutter. The feedback control circuit 3 obtains a positional error signal from a head. The head is supported by the suspension 81, is mounted on a very top of the suspension 81, and outputs the positional error signal to the feedback control circuit 3. And, the feedback control circuit 3 calculates a control variable (a second control variable) based on the positional error signal, and outputs the second control variable to the addition unit 4. The addition unit 4 adds the first control variable to the second control variable, and inputs the sum of the first control variable to the second control variable to the VCM control circuit 5. The VCM control circuit 5 drives the VCM 83 based on the inputted sum to control the positioning the head. That is to say, the calculation circuit 1, the feed-forward control circuit 2, the feedback control circuit 3, the addition unit 4 and the VCM control circuit 5 in FIG. 1 is a control unit, which obtains a frequency component of disk flutter based on the first signal and second signal, and executes control of positioning the head based on the obtained frequency component of the disk flutter.

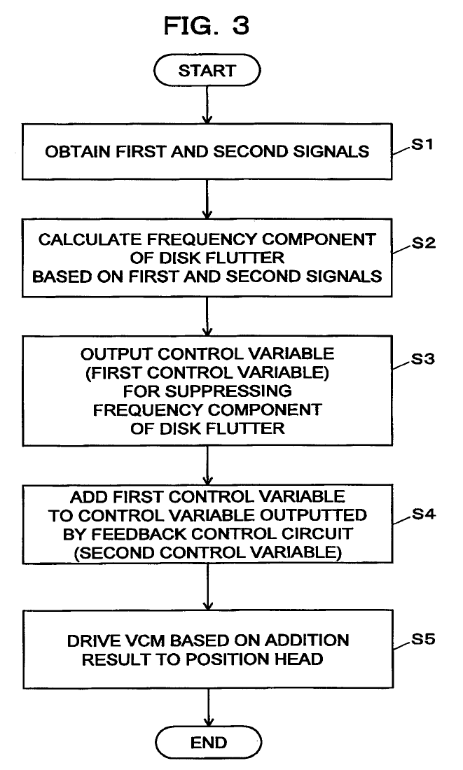

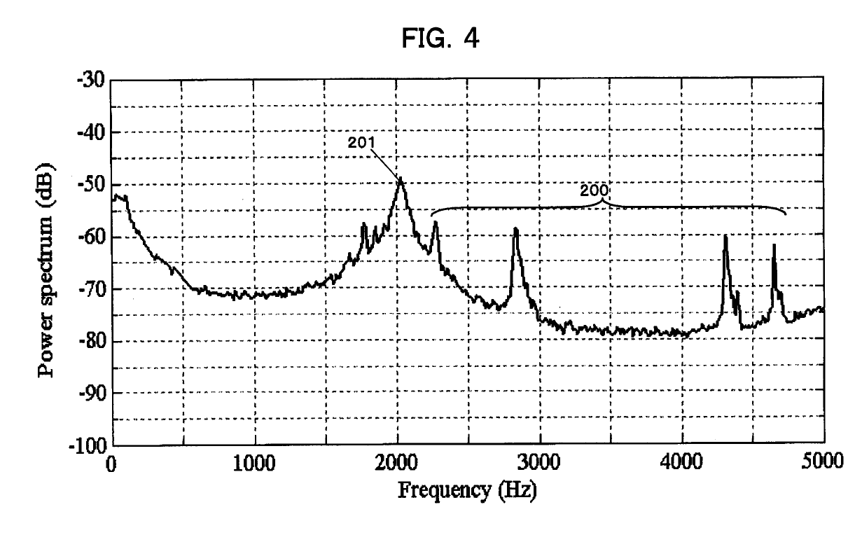

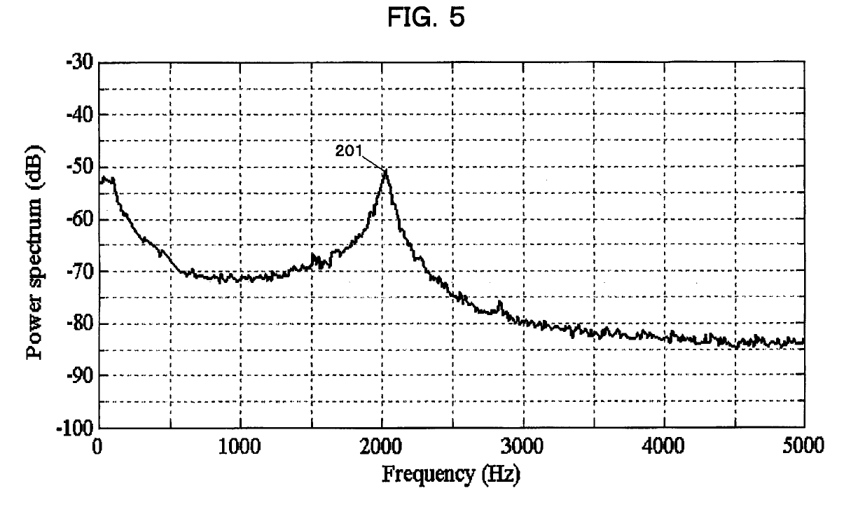

FIG. 3 is a flowchart for positioning the head in the magnetic recording apparatus according to the first embodiment. First, the calculation circuit 1 obtains the first signal detected by the sensor 100 and the second signal detected by the sensor 101 (step Si). For example, the calculation circuit 1 obtains the first signal including the disk flutter 200 and the arm flexural vibration 201, both of which is illustrated in FIG. 4, from the sensor 100. In addition, for example, the calculation circuit 1 obtains the second signal only including the arm flexural vibration 201, which is illustrated in FIG. 5, from the sensor 101.

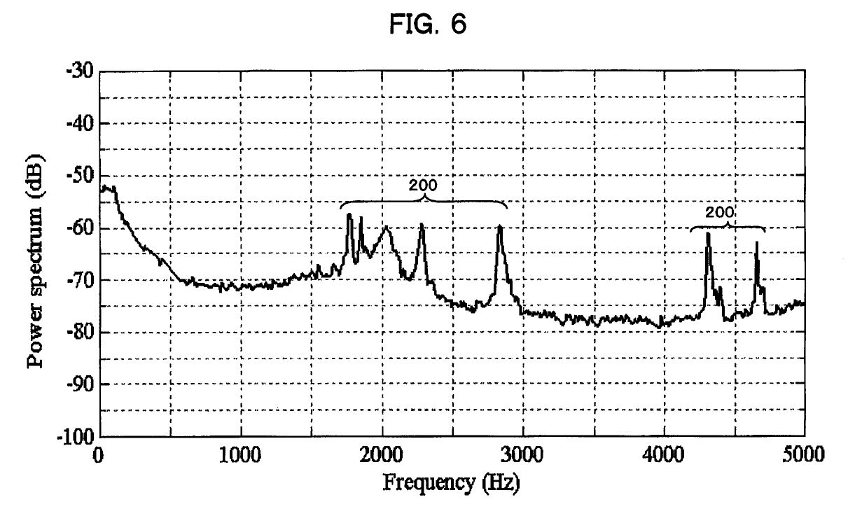

Next, the calculation circuit 1 calculates the frequency component of disk flutter based on the first signal and second signal (step S2). The calculation circuit 1 calculates, for example, a linear combination of the first signal illustrated in FIG. 4 and the second signal illustrated in FIG. 5 to calculate the frequency component of disk flutter. The calculated frequency component of the disk flutter 200 is illustrated in FIG. 6.

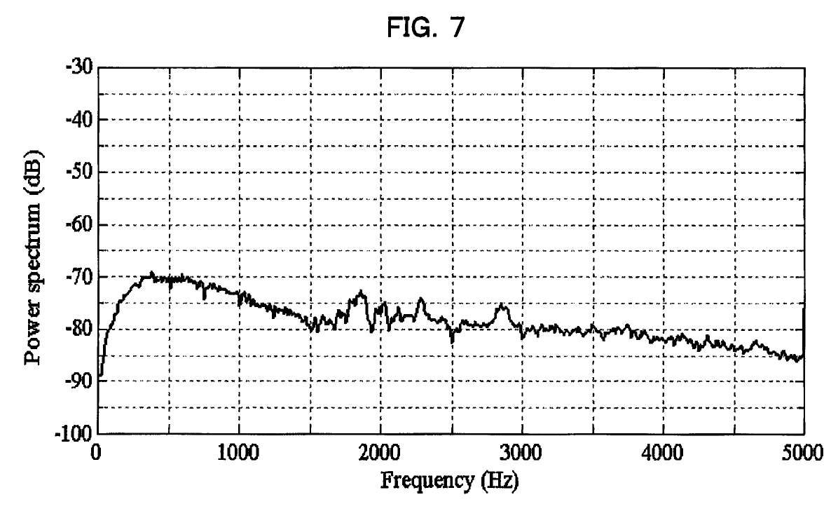

The feed-forward control circuit 2 outputs the control variable (the first control variable), for which suppress the calculated frequency component of the disk flutter, to the addition unit 4 (step S3). At that time, the control variable (the second control variable) is inputted form the feedback control circuit 3 to the addition unit 4. The addition unit 4 adds the first control variable to the second control variable outputted by the feedback control circuit 3 (step S4). The VCM control circuit 5 drives the VCM 83 based on the sum in the step S4 to execute the positioning the head (step S5). FIG. 7 illustrates a positional error signal spectrum in a case that the positioning the head is executed according to the flowchart for positioning the head in the magnetic recording apparatus of the first embodiment, which is described with reference to FIG. 3. From the positional error signal spectrum illustrated in FIG. 7, it can be seen that the disk flutter, for example, the disk flutter 200 as illustrated in FIG. 15, is suppressed which exists at about 1.5 kHz to 4.5 kHz in the positional error signal spectrum and appears before the processing of the flowchart illustrated in FIG. 3 is executed. The same positional error signal spectrum as that illustrated in FIG. 7 is obtained, even when the positioning the head is executed according to the flowchart for positioning the head in the magnetic recording apparatus in another embodiment described later.

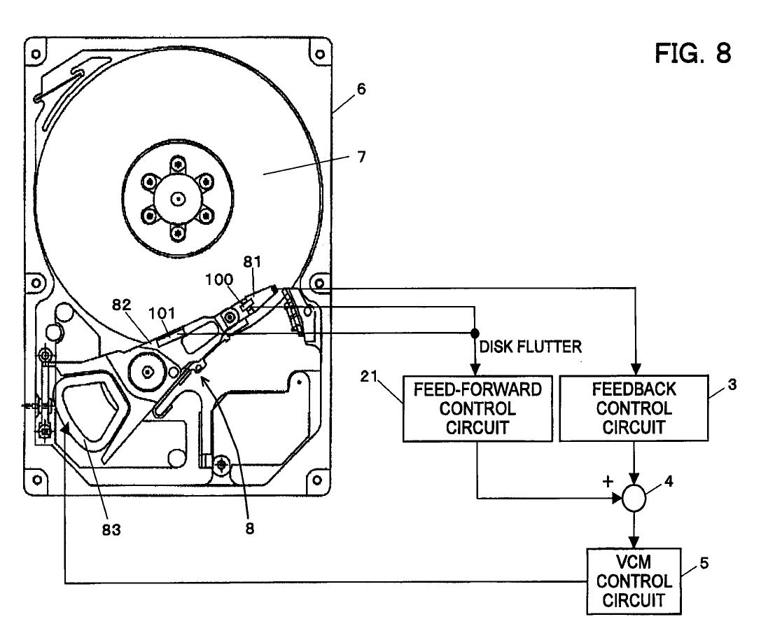

A second embodiment is now described below. FIG. 8 is an example of a block diagram of a magnetic recording apparatus according to the second embodiment. In the processing units which are provided in the magnetic recording apparatus in the second embodiment, the processing units which are given the same reference numerals as the processing units provided in the magnetic recording apparatus of FIG. 1 are the same as the processing units of FIG. 1.

In the magnetic recording apparatus of the second embodiment, the sensor 100 is physically connected to the sensor 101. In other words, the sensor 100 is connected to the sensor 101 such that the frequency component of disk flutter is inputted to a feed-forward control circuit 21. Due to this physical connection, the frequency component of disk flutter is directly inputted which is the frequency component of a signal which is obtained by removing arm flexural vibration included in the second signal detected by the sensor 101 from the first signal detected by the sensor 100. The sensor 100 may be connected to the sensor 101 in any experimentally predetermined connection method. The feed-forward control circuit 21 outputs a control variable (a first control variable) for suppressing the inputted frequency component of disk flutter. That is to say, the feed-forward control circuit 21, the feedback control circuit 3, the addition unit 4 and the VCM control circuit 5 in FIG. 8 is a control unit, which obtains a frequency component of disk flutter based on the first signal and second signal, and executes control of positioning the head based on the obtained frequency component of the disk flutter.

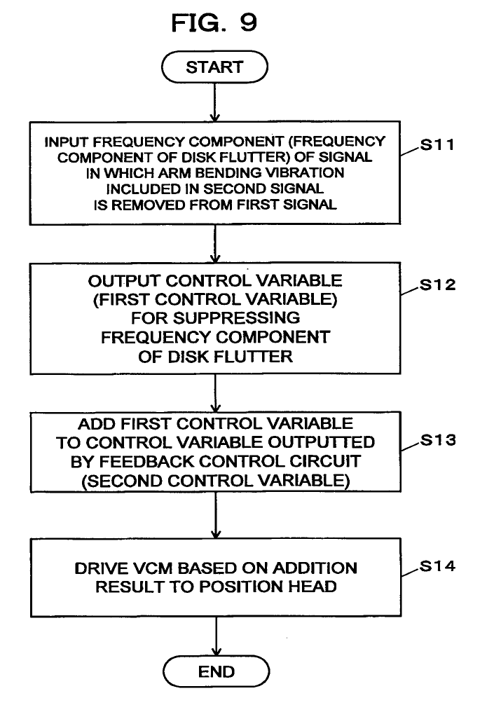

FIG. 9 is a flowchart for positioning the head in the magnetic recording apparatus according to the second embodiment. First, the frequency component of disk flutter, which is the frequency component of a signal obtained by removing arm flexural vibration included in the second signal detected by the sensor 101 from the first signal detected by the sensor 100, is inputted to the feed-forward control circuit 21 (step S11). Next, the feed-forward control circuit 21 outputs a control variable (a first control variable) for suppressing the inputted frequency component of disk flutter (step S12). At that time, the control variable (the second control variable) is inputted form the feedback control circuit 3 to the addition unit 4. The addition unit 4 adds the first control variable to the second control variable outputted by the feedback control circuit 3 (step S13). The VCM control circuit 5 drives the VCM 83 based on the sum in the step S13 to execute the positioning the head (step S14).

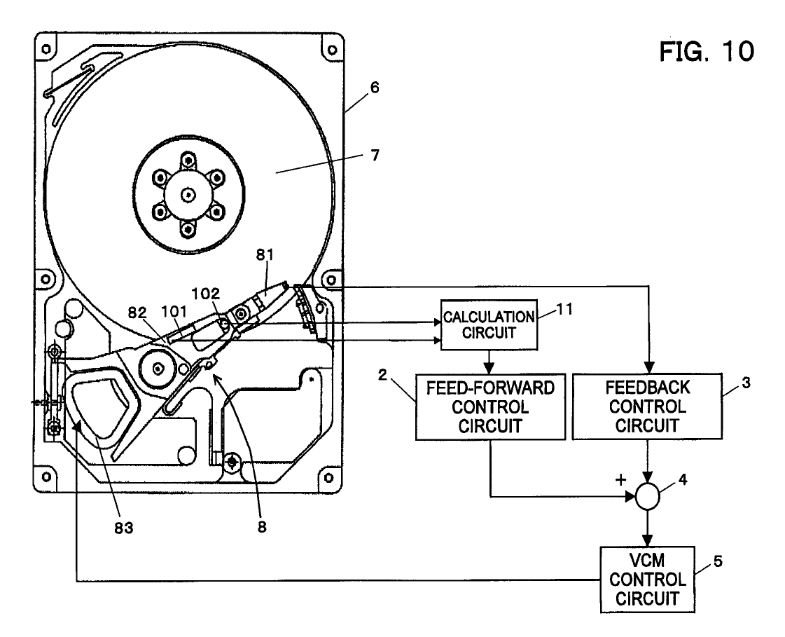

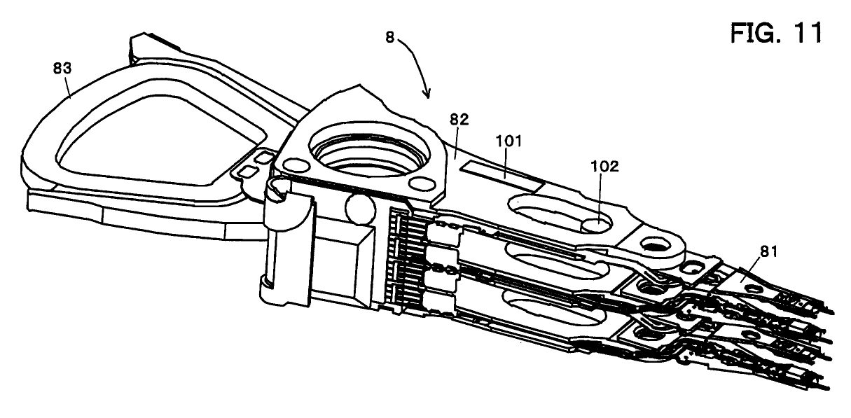

A third embodiment is now described below. FIG. 10 is an example of a block diagram of a magnetic recording apparatus according to the third embodiment. FIG. 11 is an enlarged view of the actuator 8 in FIG. 10. In the processing units which are provided in the magnetic recording apparatus illustrated in FIG. 10, the processing units which are given the same reference numerals as the processing units provided in the magnetic recording apparatus of FIG. 1 are the same as the processing units of FIG. 1.

In the magnetic recording apparatus of the third embodiment, as illustrated in FIG. 11, a non-contact displacement sensor 102 is provided on the arm 82. The non-contact displacement sensor 102 detects a signal indicating relative displacement between the arm 82 and the disk 7 of FIG. 10 provided in the magnetic recording apparatus. The signal indicating relative displacement is a first signal including disk flutter and arm flexural vibration. On the other hand, the sensor 101, which is provided on the arm 82, detects a second signal only including arm flexural vibration.

The calculation circuit 11 illustrated in FIG. 10 obtains (calculates) the frequency component of disk flutter based on the first signal detected by the non-contact displacement sensor 102 and the second signal detected by the sensor 101. The calculation circuit 11 may calculate a linear combination of the first signal detected by the non-contact displacement sensor 102 and the second signal detected by the sensor 101 to obtain the frequency component of disk flutter. For example, to obtain the linear combination, the frequency component of arm flexural vibration included in the second signal is removed from the frequency component of the signal detected by the non-contact displacement sensor 102. Thus, the calculation circuit 11, the feed-forward control circuit 2, the feedback control circuit 3, the addition unit 4 and the VCM control circuit 5 in FIG. 10 is a control unit, which obtains a frequency component of disk flutter based on the first signal and second signal, and executes control of positioning the head based on the obtained frequency component of the disk flutter.

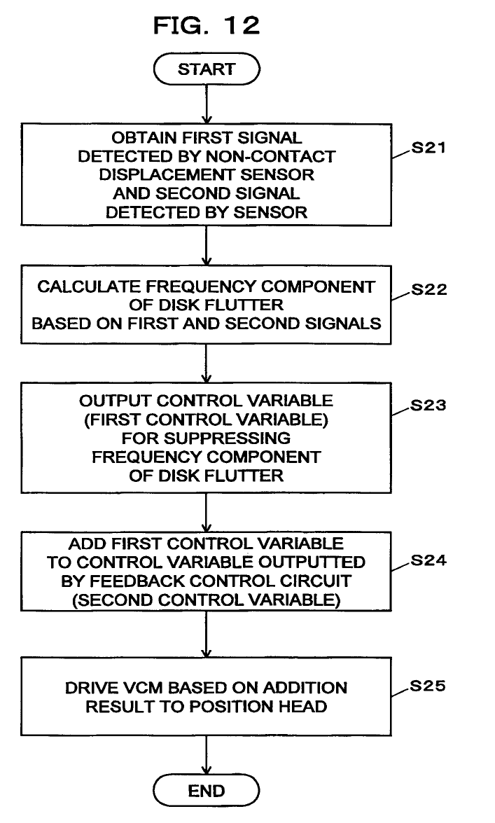

FIG. 12 is a flowchart for positioning the head in the magnetic recording apparatus according to the third embodiment. First, the calculation circuit 11 obtains the first signal detected by the non-contact displacement sensor 102 and the second signal detected by the sensor 101 (step S21). For example, the calculation circuit 11 obtains the first signal including the disk flutter 200 and the arm flexural vibration 201, both of which are illustrated in FIG. 4, from the non-contact displacement sensor 102. In addition, for example, the calculation circuit 11 obtains the second signal only including the arm flexural vibration 201, which is illustrated in FIG. 5, from the sensor 101.

Next, the calculation circuit 11 calculates the frequency component of disk flutter based on the first signal and second signal (step S22). The calculation circuit 11 calculates, for example, a linear combination of the first signal illustrated in FIG. 4 and the second signal illustrated in FIG. 5 to calculate the frequency component of disk flutter illustrated in FIG. 6.

The feed-forward control circuit 2 outputs the control variable (the first control variable) for suppressing the calculated frequency component of the disk flutter (step S23). At that time, the control variable (the second control variable) is inputted form the feedback control circuit 3 to the addition unit 4. The addition unit 4 adds the first control variable to the second control variable outputted by the feedback control circuit 3 (step S24). The VCM control circuit 5 drives the VCM 83 based on the sum in the step S24 to execute the positioning the head (step S25).

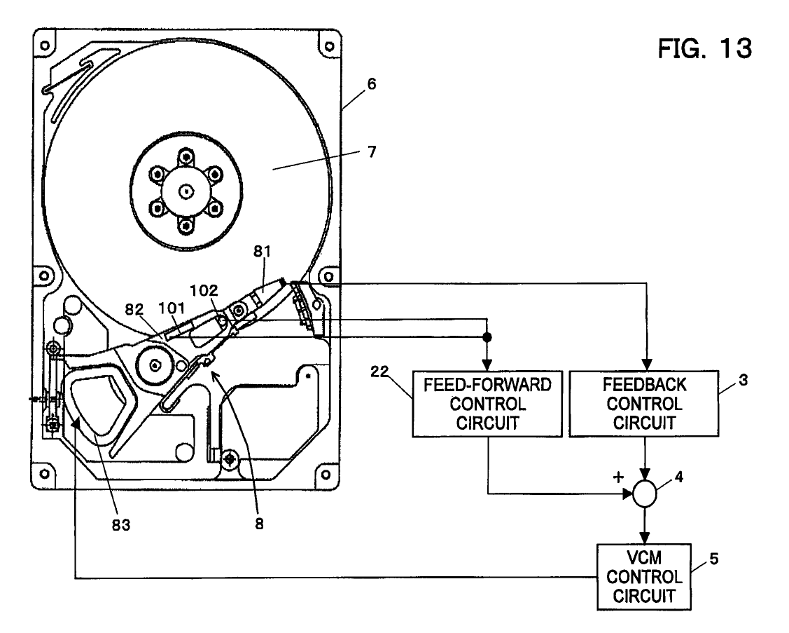

A fourth embodiment is now described below. FIG. 13 is an example of a block diagram of a magnetic recording apparatus according to the fourth embodiment. In the processing units which are provided in the magnetic recording apparatus of the fourth embodiment, the processing units which are given the same reference numerals as the processing units provided in the magnetic recording apparatus of FIG. 10 are the same as the processing units of FIG. 10.

In the magnetic recording apparatus of the fourth embodiment, the non-contact displacement sensor 102 is physically connected to the sensor 101. In other words, the non-contact displacement sensor 102 is connected to the sensor 101 is inputted to a feed-forward control circuit 22. Due to this physical connection, the frequency component of disk flutter is directly inputted which is the frequency component of a signal which is obtained by removing arm flexural vibration included in the second signal detected by the sensor 101 from the first signal detected by the non-contact displacement sensor 102. The non-contact displacement sensor 102 may be connected to the sensor 101 in any experimentally predetermined connection method. The feed-forward control circuit 22 outputs a control variable (a first control variable) for suppressing the inputted frequency component of disk flutter. That is to say, a portion including the feed-forward control circuit 22, the feedback control circuit 3, the addition unit 4 and the VCM control circuit 5 in FIG. 13 is a control unit, which obtains a frequency component of disk flutter based on the first signal and second signal, and executes control of positioning the head based on the obtained frequency component of the disk flutter.

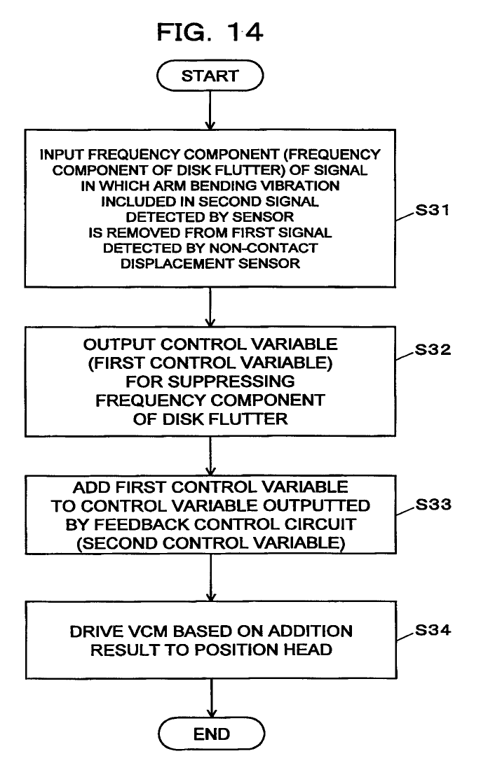

FIG. 14 is a flowchart for positioning the head in the magnetic recording apparatus according to the fourth embodiment. First, the frequency component of disk flutter, which is the frequency component of a signal which is obtained by removing arm flexural vibration included in the second signal detected by the sensor 101 from the first signal detected by the non-contact displacement sensor 102, is inputted to the feed-forward control circuit 22 (step S31). Next, the feed-forward control circuit 22 outputs a control variable (a first control variable) for suppressing the inputted frequency component of disk flutter (step S32). At that time, the control variable (the second control variable) is inputted form the feedback control circuit 3 to the addition unit 4. The addition unit 4 adds the first control variable to the second control variable outputted by the feedback control circuit 3 (step S33). The VCM control circuit 5 drives the VCM 83 based on the sum in the step S33 to execute the positioning the head (step S34).

As described above, the magnetic recording apparatus and the method for positioning the head obtain the frequency component only of disk flutter, and execute the control of positioning the head based on the obtained frequency component of the disk flutter. Therefore, according to the magnetic recording apparatus and the method for positioning a head, it is enabled to accurately control positioning the head.

All examples and conditional language recited herein are intended for pedagogical purpose to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the sprit and scope of the invention.

What is claimed is:

1. A magnetic recording apparatus comprising:
a first sensor detecting a first signal including disk flutter and arm flexural vibration;
a second sensor detecting a second signal only including the arm flexural vibration; and
a control unit obtaining a frequency component of the disk flutter based on the first signal and second signal, and executing control of positioning a head based on the frequency component of the disk flutter.

2. The magnetic recording apparatus according to claim 1, wherein the first sensor is provided on a suspension of the magnetic recording apparatus and the second sensor is provided on an arm of the magnetic recording apparatus.

3. The magnetic recording apparatus according to claim 2, wherein the first sensor is physically connected to the second sensor.

4. The magnetic recording apparatus according to claim 1, wherein the control unit calculates a linear combination of the first signal and second signal to obtain the frequency component of the disk flutter.

5. The magnetic recording apparatus according to claim 1, further comprising:
an arm; and
a disk,
wherein the first sensor is a non-contact displacement sensor which is provided on the arm, and detects a signal indicating relative displacement between the arm and the disk as the first signal.

6. The magnetic recording apparatus according to claim 5, wherein the control unit calculates a linear combination of the signal indicating relative displacement between the arm and the disk to obtain the frequency component of the disk flutter.

7. The magnetic recording apparatus according to claim 5, wherein the first sensor is physically connected to the second sensor.

8. A method for positioning a head in a magnetic recording apparatus, the method comprising:
detecting a first signal including disk flutter and arm flexural vibration by a first sensor provided in the magnetic recording apparatus;
detecting a second signal only including the arm flexural vibration by a second sensor provided in the magnetic recording apparatus; and
obtaining a frequency component of disk flutter based on the first signal and second signal, and executing control of positioning the head based on the frequency component of the disk flutter.

9. The method for positioning a head in a magnetic recording apparatus according to claim 8, wherein the first sensor is provided on a suspension of the magnetic recording apparatus and the second sensor is provided on an arm of the magnetic recording apparatus.

10. The method for positioning a head in a magnetic recording apparatus according to claim 9, wherein the first sensor is physically connected to the second sensor.

11. The method for positioning a head in a magnetic recording apparatus according to claim 8, wherein the control unit calculates a linear combination of the first signal and second signal to obtain the frequency component of the disk flutter.

12. The method for positioning a head in a magnetic recording apparatus according to claim 8, wherein the first sensor is a non-contact displacement sensor which is provided on an arm provided in the magnetic recording apparatus and detects a signal indicating relative displacement between the arm and a disk provided in the magnetic recording apparatus as the first signal.

13. The method for positioning a head in a magnetic recording apparatus according to claim 12, wherein a linear combination of the signal indicating relative displacement between the arm and the disk is calculated to obtain the frequency component of the disk flutter.

14. The method for positioning a head in a magnetic recording apparatus according to claim 12, wherein the first sensor is physically connected to the second sensor.
